(19) United States
(12) Patent Application Publication
(10) Pub. No.: US 2026/0323317 A1
(43) Pub. Date: Oct. 15, 2026

(54) METHOD AND APPARATUS FOR RESPONDING TO TRANSMISSION ERROR IN SPLIT PROCESSING

(71) Applicant: SAMSUNG ELECTRONICS CO., LTD., Suwon-si, Gyeonggi-do (KR)

(72) Inventors: Sungryeul RHYU, Suwon-si (KR); Eric YIP, Suwon-si (KR)

(21) Appl. No.: 19/483,963

(22) PCT Filed: Apr. 3, 2024
(86) PCT No.: PCT/KR2024/004306

§ 371 Date: Nov. 12, 2025

(30) Foreign Application Priority Data
May 12, 2023 (KR) 10-2023-0061991

(51) Int. Cl. H04W 24/02; H04L 1/00; H04L 41/16; H04W 28/06

(52) U.S. Cl. CPC H04W 24/02; H04L 1/0061; H04L 41/16; H04W 28/06

(57) ABSTRACT

The present disclosure relates to a 5G or 6G communication system to support higher data transmission rates. A server, in a communication system, may be configured to: receive, from a user equipment, intermediate data including result values obtained by processing at least one first layer from among a plurality of layers constituting a neural network and error detection codes for the result values; check whether there is an error in the intermediate data on the basis of the error detection codes; when an error is detected in the intermediate data, process the result values of the intermediate data by means of a second layer trained to correspond to the first layer; and derive a final result by processing an output of the second layer by means of at least one third layer subsequent to the first layer from among the plurality of layers.

### TECHNICAL FIELD

Embodiments of the disclosure relate to a method and an apparatus for responding to a transmission error in split processing between a user equipment (UE) and a server in a communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

As a network to which a neural network model is applied expands, split processing may be applied between a plurality of processing devices, for example, a UE and a server, in learning and inference of a neural network.

### DETAILED DESCRIPTION OF THE INVENTION

### Technical Problem

Embodiments of the disclosure may relate to a method and an apparatus for processing split processing between a user equipment (UE) and a server in a communication system.

Embodiments of the disclosure may provide a method and an apparatus for responding to a transmission error between split processing devices.

Embodiments of the disclosure may provide a method and an apparatus for detecting and/or mitigating a transmission error in split processing between a UE and a server.

Embodiments of the disclosure may provide a method and an apparatus for detecting and mitigating a transmission error in intermediate data during learning or inference between split processing devices.

### Technical Solution

An operating method of a user equipment in a communication system according to an embodiment of the disclosure may include obtaining configuration information about a transmission mode of intermediate data by split processing of a neural network, generating result values through processing of at least one first layer among a plurality of layers forming the neural network, generating the intermediate data by attaching error detection codes for the result values to the result values, based on the configuration information, and transmitting, to a server, the generated intermediate data including at least one subsequent second layer among the plurality of layers.

An operating method of a server in a communication system according to an embodiment of the disclosure may include obtaining configuration information about a transmission mode of intermediate data by split processing of a neural network, receiving, from a user equipment, the intermediate data including result values through processing of at least one first layer among a plurality of layers forming the neural network and error detection codes for the result values, identifying whether there is an error in the intermediate data, based on the error detection codes, processing the result values of the intermediate by a second layer trained to correspond to the first layer when the error is detected in the intermediate data, and deriving a final result by processing output of the second layer by at least one third layer following the first layer among the plurality of layers.

A user equipment in a communication system according to an embodiment of the disclosure may include a transceiver and a processor connected to the transceiver. The processor may be configured to: obtain configuration information about a transmission mode of intermediate data by split processing of a neural network; generate result values through processing of at least one first layer among a plurality of layers forming the neural network; generate the intermediate data by attaching error detection codes for the result values to the result values, based on the configuration information; and transmit, to a server, the generated intermediate data including at least one subsequent second layer among the plurality of layers through the transceiver.

A server in a communication system according to an embodiment of the disclosure may include a network interface and a processor connected to the network interface. The processor may be configured to: obtain configuration information about a transmission mode of intermediate data by split processing of a neural network; receive, from a user equipment, the intermediate data including result values through processing of at least one first layer among a plurality of layers forming the neural network and error detection codes for the result values; identify whether there is an error in the intermediate data, based on the error detection codes; process the result values of the intermediate by a second layer trained to correspond to the first layer when the error is detected in the intermediate data; and derive a final result by processing output of the second layer by at least one third layer following the first layer among the plurality of layers.

### BRIEF DESCRIPTION OF DRAWINGS

FIG. 1 illustrates a structure of a communication system according to an embodiment of the disclosure.

FIG. 2 illustrates split processing between a UE and a server according to an embodiment.

FIG. 3 is a sequence diagram illustrating a procedure for splitting and processing a neural network model in a plurality of processing devices according to an embodiment of the disclosure.

FIG. 4 illustrates the structure of a 5G media streaming (MS)-based system according to an embodiment of the disclosure.

FIG. 5 illustrates a 5G-based real-time media communication architecture supporting split processing according to an embodiment of the disclosure.

FIG. 6A and FIG. 6B are diagrams illustrating a data structure according to an embodiment of the disclosure.

FIG. 7A and FIG. 7B are diagrams illustrating a data structure including a split element according to an embodiment.

FIG. 8A, FIG. 8B, FIG. 8C, and FIG. 8D are diagrams illustrating transmission of serialized data according to an embodiment of the disclosure.

FIG. 9 illustrates a plurality of layers of a neural network model according to an embodiment of the disclosure.

FIG. 10 illustrates split processing in a plurality of processing devices according to an embodiment of the disclosure.

FIG. 11 is a diagram illustrating a response to a transmission error in split processing according to an embodiment of the disclosure.

FIG. 12 is a diagram illustrating an error learning layer trained with a normal value, an error value, and a network status according to an embodiment.

FIG. 13 is a block diagram illustrating a structure of a UE in a communication system according to an embodiment of the disclosure.

FIG. 14 is a block diagram illustrating a structure of a server in a communication system according to an embodiment of the disclosure.

### MODE FOR CARRYING OUT THE INVENTION

Hereinafter, embodiments of the disclosure will be described in detail with reference to the accompanying drawings.

In describing the disclosure, descriptions related to technical contents well-known in the art and not associated directly with the disclosure will be omitted. Such an omission of unnecessary descriptions is intended to prevent obscuring of the main idea of the disclosure and more clearly transfer the main idea. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the disclosure, the same or like reference numerals designate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Furthermore, in the following description, LTE or LTE-A systems may be described by way of example, but the embodiments of the disclosure may also be applied to other communication systems having similar technical backgrounds or channel types. For example, 5G-Advance, NR-Advance, or 6th generation (6G) mobile communication technologies developed beyond 5G mobile communication technologies (or new radio (NR)) may be included therein, and in the following description, the “5G” may be the concept that covers the exiting LTE, LTE-A, or other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

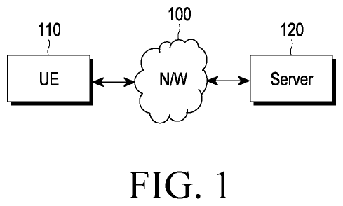

FIG. 1 illustrates the structure of a communication system according to an embodiment of the disclosure.

Referring to FIG. 1, the communication system may include a user equipment (UE) 110 configured to support wireless or wired communication and at least one server 120 that provides a communication service for the UE 110 through a network (N/W) 100 (e.g., a 5G network). The UE 110 may access a wireless network (e.g., the network 100) via a base station (e.g., node B) (not shown). The server 120 may provide a service for the UE 110 through at least one network entity of a core network (e.g., the network 100).

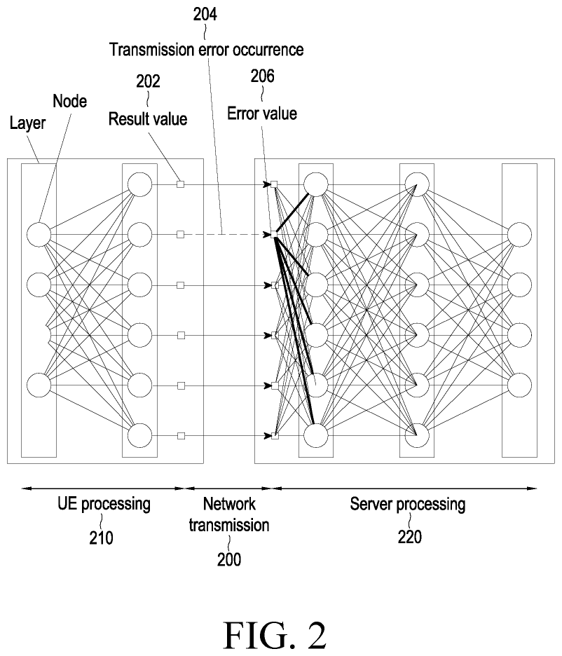

FIG. 2 illustrates split processing between a UE and a server according to an embodiment.

Referring to FIG. 2, UE processing 210 in a UE 110 may include one or more layers (e.g., a first layer and a second layer), and each layer may include a plurality of nodes. A result (e.g., a result value 202) of the UE processing 210 may be transmitted to a server 120 through a network 200. The result may be input to server processing 220 that includes one or more layers (e.g., a third layer, a fourth layer, and a fifth layer). The result may be processed by a plurality of nodes in each layer.

A data distortion (e.g., an error value 206) due to a transmission error 204 may occur while transmitting the result (e.g., the result value 202) to the server 120 through the network 200 after the UE processing 210. For example, while transmitting the result (e.g., the result value 202) obtained in the UE 110 to the server 120, calculation result values of some nodes (e.g., at least one node in the second layer) may not be transmitted or may be changed to a completely different value (e.g., the error value 206) due to distortion of some bits. When the distorted result is applied to nodes in subsequent layers (e.g., the third to fifth layers), an overall calculation value and a derived result in the server processing 220 are affected.

When nodes in some layers of a neural network are disconnected, the performance of the model network may be affected. When a node is disconnected, the node no longer receives input from a node in a previous layer, and does not contribute to output of the current layer, which leads to information loss and makes it impossible to learn a basic pattern of data.

As illustrated in FIG. 2, when the transmission error 204 occurs in the transmitted result (e.g., the result value 202) after the UE processing 210, output data (e.g., the error value 206) of a node where the transmission error 204 occurs affects all subsequent layers (e.g., the third to fifth layers of the server processing 220).

De-facto standards (e.g., H5) and standard documents (e.g., neural network exchange format (NNEF) and open neural network exchange (ONNX)) define methods for storing a layer configuration and per-node weight values of a neural network model. Intermediate data between layers is generated and consumed during a calculation in a processor (e.g., a graphics processing unit (GPU)), and may thus require a standard for storing the same. A network model, such as NNEF, may store data separately in two file formats of graph and dat. Graph may describe a data structure. Dat may include data values in a format of being dumpable to memory for fast loading. However, as mentioned above, NNEF does not support transmission of intermediate data. Since the dat format lists data values consecutively, when the dat format is used, a receiving device is unable to know which part of intermediate data an error occurs. When data of a node detected as having an error has a certain value, the value may be an unlearned value or may act as an excessive outlier in inference and learning, distorting an overall result.

In neural network learning and inference, a connection between layers is achieved within a GPU and a memory area of the GPU, and thus a storage method during transmission or a method for responding to a transmission error may not be considered. However, when splitting and processing a model and transmitting an intermediate result value (e.g., intermediate data) through a network (e.g., the network 100 or 200), a method for transferring data (e.g., intermediate data) stored in memory of one processing unit (e.g., a GPU) to another processing unit (e.g., a central processing unit (CPU)) for storage, a method for transmitting the data, and a method for verifying the integrity of received data and handling an error may be required.

In embodiments of the disclosure, a network of a neural network model may be defined as a set of a plurality of layers connected in parallel or series. A layer may be defined as including one or more nodes. A node may be defined as including an element(s) or an element(s) in a multidimensional array. An element may be defined as having a weight. A weight may be defined as a value that is initialized to a random or specified value and then modified by learning. A result value (e.g., intermediate data) of a layer may be defined as a calculated value derived through a calculation of result values of nodes in a previous layer and weights of the nodes of the layer.

Embodiments of the disclosure provide synchronization and serialization for transmitting intermediate data, which is a processing result of one processing device, to another processing device when processing in a network of a neural network model is split into one or more parts, which are performed separately by a plurality of processing devices (e.g., a UE and a server), and a connection between the devices is based on a mobile communication network.

Embodiments of the disclosure provide a method in which a processing device receiving intermediate data stored and transmitted by serialization determines whether a value specified in the intermediate data is normal or has changed due to an error occurring during transmission.

Embodiments of the disclosure provide a method for responding to an error value when an error is determined to have occurred in intermediate data.

An embodiment of the disclosure may provide a service negotiation and processing procedure for splitting processing of a neural network model in a network (e.g., a mobile communication network) and processing the same in a plurality of processing devices.

In the disclosure, a network of a neural network model may be defined as a set of a plurality of layers connected in parallel or series. A layer may be defined as including one or more nodes. A node may be defined as including an element(s) or an element(s) in a multidimensional array. An element may be defined as having a bias, an activation function, and/or a weight. A weight may be defined as a value that is initialized to a random or specified value and then modified by learning. A result value (e.g., intermediate data) of a layer may be defined as a calculated value derived through a calculation of result values of nodes in a previous layer and weights of the nodes of the layer.

Split processing for a neural network model may include splitting a neural network model into one or more segments, transmitting the split model segments to one or more processing devices, performing processing in the one or more processing devices, and connecting the processing by transmitting intermediate data via a local or mobile communication network. The processing devices supporting split processing according to the disclosure may include, for example, a mobile communication UE or a cloud/edge server.

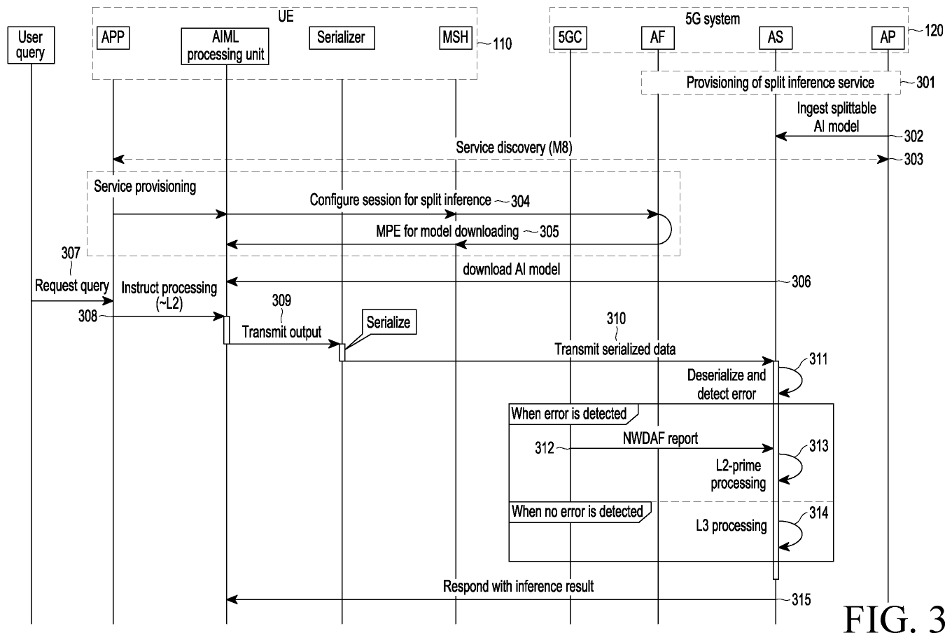

FIG. 3 is a sequence diagram illustrating a procedure for splitting and processing a neural network model in a plurality of processing devices according to an embodiment of the disclosure. The following procedure may include service negotiation and processing in a mobile communication network (e.g., a 5G system).

Referring to FIG. 3, in operation 301, an application provider (AP) communicates with an application function (AF) of a 5G system to transmit information about a service to be provided. The AF may generate an application server (AS) (e.g., the server 120) or prepare a resource for providing the service in an already generated AS. The resource may include, for example, a repository for a neural network model and a calculation device for model processing. After completely allocating and preparing the resource of the AS, the AF may transmit information (e.g., provisioning information) related to the resource to the AP.

In operation 302, the AP may transmit information related to a neural network model to the AS. The AS may ingest information about a splittable AI model from the information.

In operation 303, a UE may execute an application (‘App’), and the App may communicate with the AP to perform split artificial intelligence and machine learning (AIML) processing service discovery to find a split processing service for the neural network model for desired learning or inference, thereby receiving information for communicating with the AF to receive the service.

In operation 304, the App may invoke an application programmable interface (API) of an AIML processing unit (APU) within the UE to execute a split neural network processing service. The APU may communicate with the AF via a media session handler (MSH) to negotiate with the AF for information about a serialization element and a transmission session for exchanging intermediate data generated during split learning or split inference with the AS.

In operation 305, as a result of the negotiation, the MSH may receive information (e.g., downlink location information) for downloading the neural network model and/or information (e.g., uplink location information) for transmitting serialized data, and may transmit the received information to the APU.

In operation 306, the APU may receive (e.g., download) configuration information (e.g., at least part of AI model information as in Table 2) about a part of the neural network model to be implemented in the UE from the AS.

In operation 307, the App may receive instruction input (e.g., ‘Request query’) for learning or inference from a user.

In operation 308, the App may instruct the APU to process the neural network model (e.g., first and second layers (L1 and L2)) in the UE.

In operation 309, the APU may transmit intermediate data including result values as output of the processing to a serializer. The serializer may serialize the intermediate data to generate serialized data (e.g., intermediate data in a serialized format). In an embodiment, the serialized data may include result values of the processing and error detection codes corresponding thereto.

In operation 310, the serialized data generated by the serializer may be transmitted to the AS via the mobile communication network.

In operation 311, the AS may deserialize the received serialized data. Deserialization may include parsing the result values according to the layer structure of the network and error detection using the error detection codes.

In operation 312, when an error is detected through the deserialization, the AS may receive status information related to a network status from a 5G core network (5GC) (e.g., at least one network entity) through the AF. The status information (e.g., a network data analytics function (NWDAF) report and/or an event exposure (EVEX) report) related to the network status provided by the 3GPP 5GC according to a standard, such as an NWDAF or EVEX, may include at least one of user data traffic and patterns, the location, mobility, and usage of the UE (e.g., the UE 110), network infrastructure and service statuses, network and service bottleneck situations, quality-of-service (QoS) information, radio access network (RAN) and core network statuses, real-time traffic analysis data, a network security status, failure diagnosis and prevention data, or data analysis information for a machine learning algorithm. An error learning layer trained based on at least one piece of the information included in the status information may be selected for the processing of the neural network model in the AS.

In operation 313, the selected error learning layer may be used, and output of the error learning layer may be applied as input to a next layer. In one example, when the first layer (L1) and the second layer (L2) of the neural network model are executed in the UE 110, the error learning layer used in the AS may be an L2-prime layer that predicts a normal value for the second layer (L2). The L2-prime layer may process the result values included in the serialized data before L3. Output of the L2-prime layer may be transmitted to next layers (e.g., a fourth layer (L4) and a fifth layer (L5)) via the third layer (L3), and a final result may be derived by the layers (L3, L4, and L5).

When determining no error has occurred during transmission of the received serialized data in the deserialization in operation 311, the deserialized data (e.g., output data from L2) may be transmitted to the next layers (L4 and L5) via the third layer (L3), and a final result may be derived in operation 314.

In operation 315, the final result (e.g., an inference result) derived through operation 313 or operation 314 may be returned by the AS to the APU of the UE 110.

The foregoing operations may be based on system architecture in TS 26.501, which defines 5G media streaming (5GMS) of 3GPP system aspects 4 (SA4).

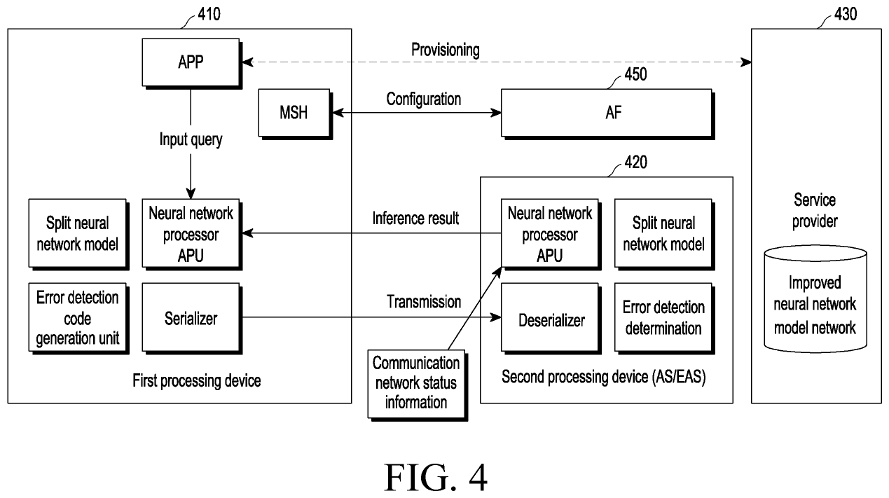

FIG. 4 illustrates the structure of a 5GMS-based system according to an embodiment of the disclosure.

Referring to FIG. 4, a first processing device 410 (e.g., the UE 110) may include at least one of an App, an MSH, an APU responsible for processing a neural network, a serializer, an error detection code generation unit, or a split neural network model repository. A second processing device 420 (e.g., the server 120 or an AS) may include at least one of an APU responsible for processing a neural network, a deserializer, an error detection code determination unit, or a split neural network model repository.

Processing devices (e.g., the first processing device 410 and the second processing device 420) supporting split processing may share information about the structure and weight value of a split neural network model that the devices are responsible for processing among the entire neural network model through service provisioning by the App or session configuration via the MSH. The service provisioning may be performed between a service provider 430 and the App of the first processing device 410. The session configuration may be performed between an AF 450 (e.g., at least one network entity of a 5GC) and the MSH of the first processing device 410.

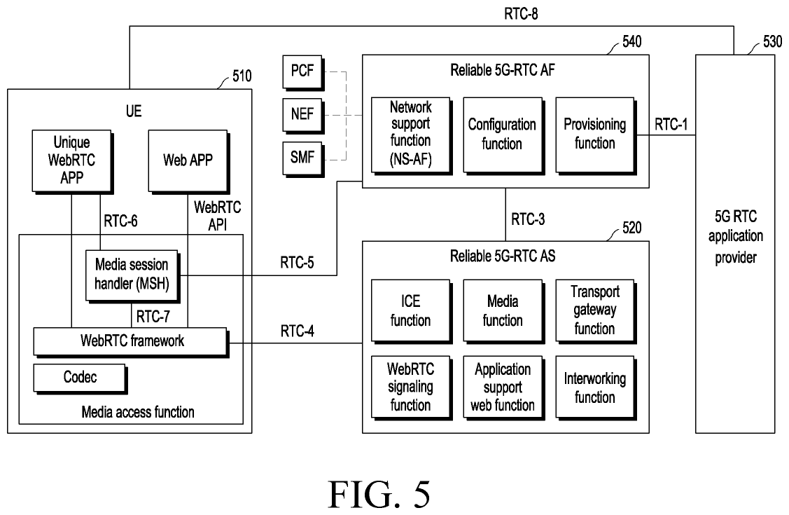

FIG. 5 illustrates a 5G-based real-time media communication architecture supporting split processing according to an embodiment of the disclosure. The illustrated real-time media communication architecture may be based on, for example, TS 26.506.

Referring to FIG. 5, a UE 510 (e.g., the UE 110) may include an App (e.g., a native WebRTC App) performing web real-time communication (RTC), a web App, and a media access function. The media access function may include an MSH, a web RTC framework, and a codec. The MSH may communicate with an AF 540 supporting 5G-RTC via an RTC-5 interface.

The 5G-RTC AF 540 may include a network support (NS) function (NS-AF), a configuration function, and a provisioning function, and may communicate with a policy control function (PCF), a network exposure function (NEF), and a session management function (SMF) of a 5G network. The provisioning function may communicate with a 5G RTC application provider 530 (e.g., an AP) via an RTC-1 interface.

The web RTC framework may communicate with an AS 520 (e.g., the server 120) supporting 5G-RTC via an RTC-4 interface. The 5G-RTC AS 520 may include an interactive connectivity establishment (ICE) function, a media function, a transport gateway function, a WebRTC signaling function, an application support web function, and an interworking function.

An APU of the UE 510 may negotiate with the 5G-RTC AF 540 or the WebRTC signaling function of the 5G-RTC AS 520 rather than a 5GMS AF (not shown) for service preparation, and the media function of the 5G-RTC AS 520 may be responsible for receiving and processing a neural network model.

An embodiment of the disclosure may provide a method for indicating a layer in which error-responsive learning is performed in a storage format of a neural network model that supports split processing.

NNEF, which is an open-source standard for storing a neural network model, may use a file format (e.g., * graph) representing model network structure information and a file format (e.g., * dat) representing weight information about a node of a layer to store data of a neural network model. Graph information may include structure information of dat information. A processing device may generate a data structure of a model network by using graph information and then map a tensor value of a dat file to the data structure. Embodiments of the disclosure may provide a method for indicating a layer split point for split processing and a method for identifying an error-responsive learning layer that is used only when an error occurs.

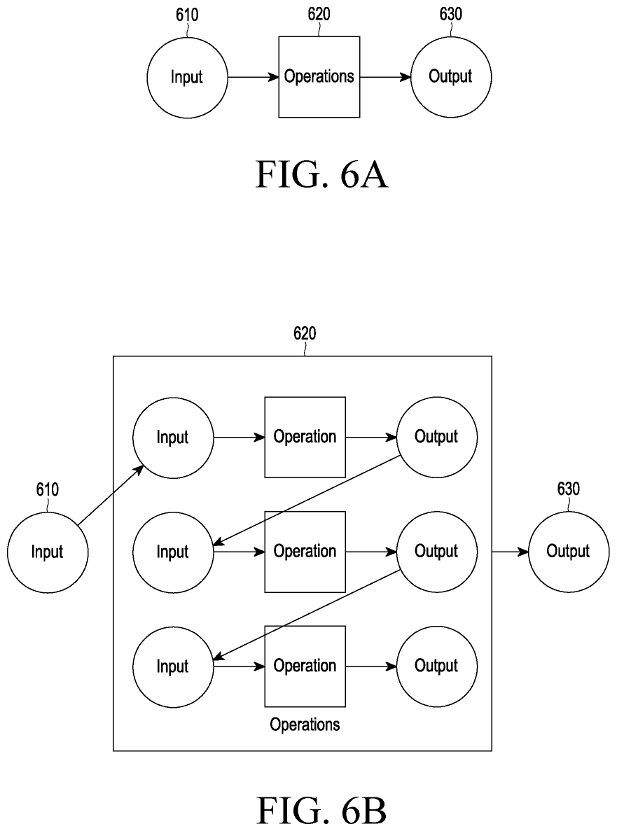

FIG. 6A and FIG. 6B are diagrams illustrating a data structure according to an embodiment of the disclosure.

Referring to FIG. 6A, the data structure (e.g., graph information of NNEF) is in a JavaScript object notation (JSON) format, and may describe input, output, and one or more operations of the entire model by using elements, such as ‘input’ 610, ‘output’ 630, and ‘operations’ 620. ‘Operations’ 620 may correspond to at least one layer described in embodiments of the disclosure. ‘Input’ 610 and ‘output’ 630 may correspond to input and output of the layer. Referring to FIG. 6B, output of one operation may be input of a next operation.

Specific attributes of the layer may be indicated, for example, by ‘name,’ ‘type,’ ‘shape,’ and/or ‘value.’ The name may indicate a neural network calculation formula of the layer, the type may indicate the data type of a variable, the shape may indicate the form of a multidimensional array, and the value may indicate a parameter value of a calculation.

Table 1 and Table 2 below illustrate a data structure of NNEF which configures a neural network model according to an embodiment.

TABLE 1

```
  input {
    name: “input_tensor”
    type: “float32”
    shape: [1, 28, 28, 3]
  }
  output {
    name: “output_tensor”
    type: “float32”
    shape: [1, 10]
}
```

TABLE 2

```
  operation {
    name: “conv2d”
    inputs {
      name: “input_tensor”
    }
    outputs {
      name: “ output_tensor”
      type: “float32”
      shape: [1, 28, 28, 32]
    }
    attributes {
      name: “filter”
      type: “float32”
      shape: [5, 5, 3, 32]
      value: [0.1, 0.2, ..., 0.9]
    }
}
```

As described above, an operation may include at least one input, at least one output, or at least one attribute. The at least one input or the at least one output may include at least one of a name, a type, or a shape. The at least one attribute may include at least one of a name, a type, a shape, or a value.

A method for describing a neural network model structure according to the disclosure may indicate a separable layer in view of split processing.

Table 3, Table 4, and Table 5 below illustrate a data structure defining a neural network model that supports split processing according to an embodiment.

TABLE 3

```
  input {
    name: “input_tensor”
    type: “float32”
    shape: [1, 28, 28, 3]
  }
  output {
    name: “output_tensor”
    type: “float32”
    shape: [1, 10]
  }
  split {
  name: “max_pool”
  attributes {
  error_prune_input {
      name: “packet_error_report”
      type: “float32”
      shape: [1, 255]
    }
  error_prune_operation: “max_pool_error_prune”
  }
}
```

TABLE 4

```
  operation {
    name: “conv2d”
    inputs {
      name: “input_tensor”
    }
    outputs {
      name: “conv_output”
      type: “float32”
      shape: [1, 28, 28, 32]
    }
    attributes {
      name: “filter”
      type: “float32”
      shape: [5, 5, 3, 32]
      value: [0.1, 0.2, ..., 0.9]
    }
}
```

TABLE 5

```
  operation {
    name: “max_pool”
    inputs {
      name: “conv_output”
    }
    outputs {
      name: “output_tensor”
      type: “float32”
      shape: [1, 14, 14, 32]
    }
    attributes {
      name: “window_shape”
      type: “integer”
      value: [1, 2, 2, 1]
    }
}
```

TABLE 6

```
  operation {
    name: “max_pool_error_prune”
    inputs {
      name: “conv_output”
    }
    inputs {
      name: “packet_error_report”
    }
    outputs {
      name: “conv_output”
  type: “float32”
      shape: [1, 28, 28, 32]
    }
    attributes {
      name: “filter”
      type: “float32”
      shape: [5, 5, 3, 32]
      value: [0.1, 0.2, ..., 0.9]
    }
}
```

As illustrated above, the data structure of configuration information may include ‘input,’ ‘output,’ ‘operations,’ and ‘split.’ The ‘split’ element may include ‘name’ of an ‘operation’ element. Data specified in ‘input’ of ‘operation’ specified by the ‘split’ element may be intermediate data. The intermediate data may be output from a previous processing device (e.g., a first processing device), and the ‘operation’ (e.g., ‘max_pool’) specified by the ‘split’ element may be executed by a next processing device (e.g., a second processing device).

‘Attributes’ of the ‘split’ element may include error_prune_input and error_prune_operation. When an error is detected in input of the ‘max_pool’ operation, error_prune_input may indicate input to be additionally applied, and error_prune_operation may indicate an operation to be additionally executed.

For example, the data structure may include ‘split,’ which is a top-level element describing the entire model, and ‘name’ of ‘split’ may indicate a second operation ‘max_pool’. In addition, input_tensor as input of the entire model may be connected to conv2d that is a first operation, conv_output as output of the first operation may be connected as input of max_pool that is the second operation, and output_tensor as output of the second operation may be connected as output of the entire model. The ‘split’ may indicate that the second operation named max_pool is the location of split processing. When an error is detected in the output of the second operation, a processing device that supports error_prune_input and error_prune_operation may perform an operation of ‘max_pool_error_prune’ in which packet_error_report and conv_output specified as error_prune_input of ‘attributes’ are received as inputs, and may connect conv_output as output to the ‘max_pool’ operation. The ‘max_pool’ operation may derive the final output of the entire model.

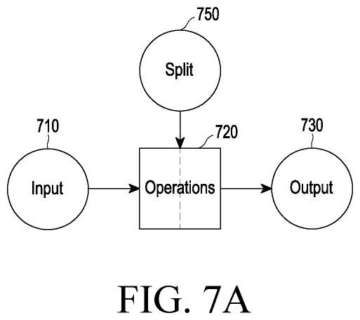

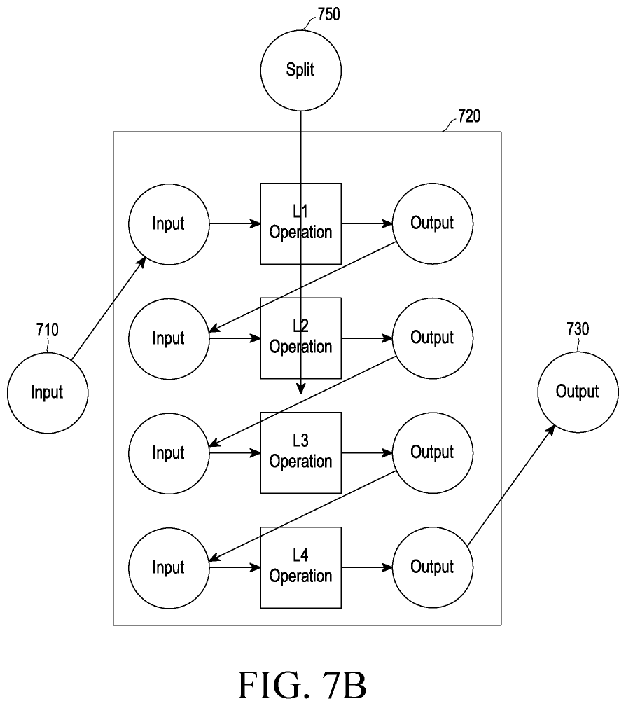

FIG. 7A and FIG. 7B are diagrams illustrating a data structure including a split element according to an embodiment.

Referring to FIG. 7A, the data structure may include elements, such as ‘input’ 710, ‘operations’ 720, ‘output’ 730, and ‘split’ 750. Referring to FIG. 7B, output of one operation may be input of a next operation. ‘Split’ may indicate an operation (e.g., ‘L3 operation’) to be subjected to split processing. ‘Split’ may include ‘attributes’ indicating an operation to be used as an error learning layer.

An embodiment of the disclosure may provide a method for serializing intermediate data.

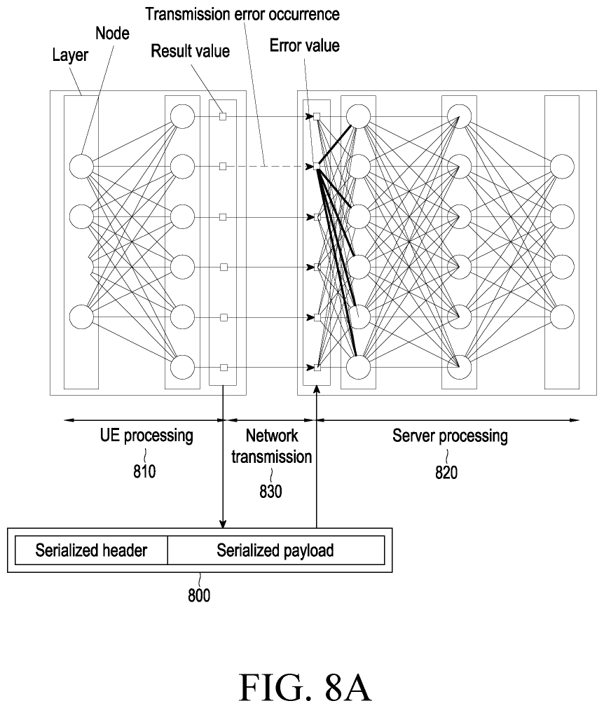

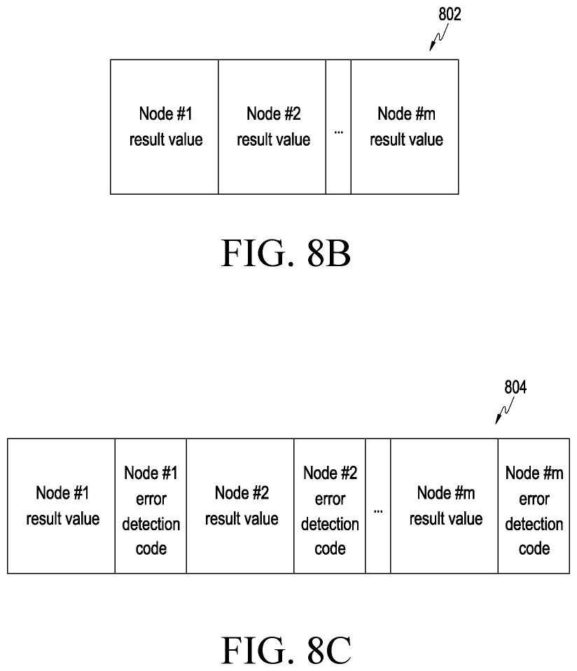

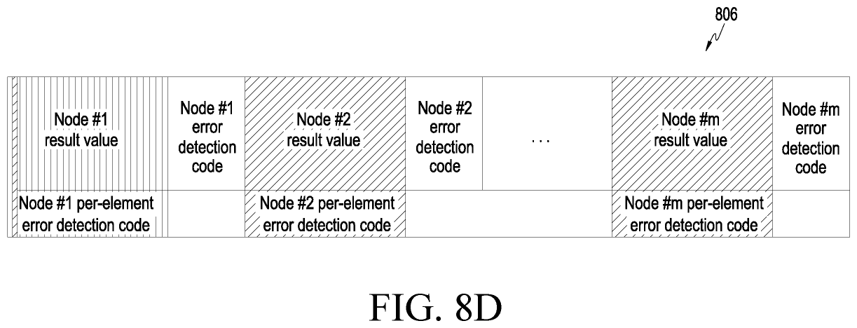

FIG. 8A, FIG. 8B, FIG. 8C, and FIG. 8D are diagrams illustrating transmission of serialized data according to an embodiment of the disclosure.

Referring to FIG. 8A, processing devices that support split processing (e.g., UE processing 810 and server processing 820) may obtain configuration information (e.g., the AI model information downloaded in operation 306) about intermediate data in a serialized format (e.g., serialized data 800) received from a previous processing device or to be transmitted to a subsequent processing device via network transmission 830.

The configuration information may further include information indicating at least one of common attributes of the intermediate data (e.g., the serialized data 800), for example, a header format, the number of data transmissions, a total data size before compression, a data compression method, a data compression range, an identifier of a layer in data, the number of nodes in data, a data array size per node, a data format per node, a storage size of a data format, an error detection method for data, a storage size of an error detection code, an order in which data and an error detection code are specified, or a node initialization value.

The header format may indicate whether a header is in a JSON format, a bit allocation format, or a type-length-value format.

The number of data transmissions may indicate the number of times the intermediate data is transmitted per second.

The total data size before compression may indicate the size of the intermediate data before compression in bytes.

The data compression method may indicate whether the intermediate data is compressed and a compression method. A value of 0 indicates no compression, and values greater than 1 may indicate an identifier of a method used for compression.

The data compression range indicates whether the intermediate data is compressed per node or as a whole.

The identifier of the layer in the data specifies an identifier for identifying a layer that generates the intermediate data in a neural network model.

The number of nodes in the data may indicate the number of nodes included in the intermediate data. The number of nodes is already determined in a model network, but may be included in the intermediate data for faster processing.

The data array size per node may indicate the size of each dimension in an n-dimensional array as an array. For example, when respective dimensions of an n-dimensional array have sizes of j, k, and l, the sizes are expressed as arrays in an order of [j, k, l].

The data format per node may indicate the format of data held by a node, such as an integer type, a real number type, or a 32-bit floating-point representation of a real number (big-endian float32). For an n-dimensional array, a variable format may be expressed as an array.

The storage size of the data format may indicate a size in which the data format is stored in bytes. For an n-dimensional array, the storage size of the data format may be expressed as an array.

The data error detection method may indicate an identifier of a method used to detect an error in data. The detection method may be specified for each node and/or each element described below.

The storage size of the error detection code may indicate a size in which an error detection code is stored in bytes. The storage size may be specified for each node and/or each element described below.

The order in which the data and the error detection codes are specified may indicate, for example, whether to specify a node identifier and an error detection code for each node, whether to specify an error detection code for each element, or whether to specify all nodes and then specify error detection codes of the nodes and elements together. A method for combining a node, a node element, a node error detection code, and an element error detection code is not limited to the examples.

FIG. 8B, FIG. 8C, and FIG. 8D illustrate examples of a serialized payload in the serialized data 800 according to a configuration according to an embodiment of the disclosure.

Referring to FIG. 8B, a serialized payload 802 may include result values of nodes, for example, a result value of node #1, a result value of node #2, . . . , and a result value of node #m.

Referring to FIG. 8C, a serialization payload 804 may include result values of nodes and error detection codes for the respective result values of the nodes, for example, a result value of node #1, an error detection code of node #1, a result value of node #2, an error detection code of node #2, . . . , and a result value of node #m and an error detection code of node #m.

Referring to FIG. 8D, a serialization payload 806 may include an error detection code for each element of an array of nodes and an error detection code for each result value of the nodes, for example, a result value of node #1, an error detection code for each array element of node #1, an error detection code of node #1, a result value of node #2, an error detection code for each array element of node #2, an error detection code of node #2, . . . , and a result value of node #m, an error detection code for each array element of node #m, and an error detection code of node #m.

The node initialization value is a value for initializing data of a node when determining that an error has occurred in the node. The node initialization value may be determined as 0, 1, 0.5, or an eigenmatrix depending on the type, characteristics, and purpose of a layer. When an error is detected in serialized data, a device in a subsequent operation receiving the serialized data from a device in a previous operation (e.g., a previous layer) may initialize a corresponding node or element using the initialization value, and then perform processing in the subsequent operation.

As illustrated in FIG. 8A, the serialized intermediate data, for example, the serialized data 800, may include a serialized header and a serialized payload.

The serialized header may be configured in the JSON format, the bit allocation format, or the type-length-value format. The serialized header in the JSON format may include a field name and a field value separated by a semicolon. The serialized header in the bit allocation format may indicate which field values are specified by toggling a bit of a flag, and then include designated field values. The serialized header in the type-length-value format may include a length and a value for a field of a designated type.

In an embodiment, when the header of the intermediate data has the same attribute value as that described in the configuration, the attribute value may not be redundantly specified in the header, or when an attribute value is separately specified, the header may indicate a different configuration. For example, after configuring no compression in a configuration operation, it is indicated that compression is performed in header information in nth transmission, the intermediate data may be compressed and transmitted, and the intermediate data may be transmitted without compression in (n+1)th transmission.

In addition to the foregoing content of the configuration, the header of the intermediate data may further include specific values that vary for each intermediate data, such as an identifier of data to be inferred or learned or at least one of a query and a query identifier. When the size of the intermediate data is relatively small, one piece of serialized data may include a plurality of pieces of intermediate data for a plurality of pieces of data (e.g., frames).

The identifier of the data may be an identifier of data applied as input to a neural network model to be inferred or learned. Examples of the data may include video media or images, and the identifier may include additional attribute information, such as a frame number, an image identifier, or a location where an image is captured. When receiving a result of processing in a server, a UE may also receive an identifier of data, thereby determining which UE-learned data the result correspond to.

The query identifier is included when the entire query is transmitted along with the intermediate data. The server may input a received query to a second or third alternative neural network model along with a processing result from the UE, and may return an inference result of the alternative neural network model, a model identifier, and a query identifier. When determining that the result from the UE is more appropriate, the server may receive a model via a model identifier, and may use the model in future learning or inference.

As described above, serialized data (e.g., the serialized data 800) may include a calculated value (e.g., result values) resulting from calculations of nodes in a layer and an error detection code for detecting an error in the calculated value.

The intermediate data, which is output of a layer, may be generated in an n×n matrix of each node by m nodes. Storing multidimensional array data in C or Python language follows row-major order in which an innermost dimension element in a multidimensional array is stored first, followed by a next dimension element.

According to row-major order, when a three-dimensional matrix with n=3 has sizes of j, k, and l, the storage order of array elements is as follows.

arr[0,0,0], arr[0,0,1], arr[0,0,2], . . . , arr[0,0,1−1], arr[0,1,0], . . . , arr[1,k−1,2], arr[j−1,k−1,1−1]

In the above example, the number of nodes is m, and the number of intermediate data elements is m×j×k×l.

Embodiments of the disclosure may detect an error and store an error detection code for each node and element by different ways.

When an error detection code is generated for each node, m node error detection codes may be generated in the above example. When an error detection code is generated for each element, m×j×k×l error detection codes may be generated.

Error detection methods may include a parity bit, a checksum, a cyclic redundancy code check (CRC), or a forward error check (FEC), and the types of error detection codes for nodes and elements are specified in the configuration or attributes of the header of the intermediate data.

Detection of an error in node data may be performed on the entire n-dimensional array data of each node. For example, serialized data of a layer including m nodes may include m node error detection codes. For example, when CRC-32 is used, a 32-bit code generated by applying a CRC-32 code to all data of each node is a CRC-32 code.

Detection of an error in an element of node data may be performed on all elements of n-dimensional array data of each node. For example, for an array including three dimensions and having sizes of j, k, and l, a parity bit may be calculated for each element. For example, a 32-bit floating-point value is represented as a combination of 1s and 0s, in which when an even number of 1s is represented as 1 and an odd number of 1s as 0, a receiving device may determine occurrence of an error in each element by comparing an array element value with a parity bit.

In the above example, for a node with a three-dimensional array where j, k, and l are 32, 32, and 32, respectively, 32×32×32 float32 floating-point data has a size of 131,072 KB since 4 bytes are required for each element. When a parity bit is used as an error detection code for each element, the size of the error detection code is be a parity bit of 4 KB for data of 131,072 KB. Here, CRC-32 is used as an error detection code for each node, the error detection code has a size of 4 bytes.

Node data may be compressed for transmission efficiency. Here, all node data may be compressed for higher transmission efficiency, or separate node data may be compressed to prevent a transmission error from affecting the entire serialized data.

When compression is performed on all node data, serialized data including at least one of the node data, an error detection code for the node data, or an error detection code for an element may be compressed.

When compression is performed on separate node data, error detection codes for the node data and a node element may be compressed, and an identifier and a node compression error detection code may be added.

An embodiment of the disclosure may provide a method for detecting an error in node data and initializing node data.

A processing device supporting split processing may receive serialized intermediate data (e.g., serialized data) from a previous device, and may then identify the type and range (node or element) of error detection codes used for the received data and whether the data is compressed, based on a configuration and a serialized header, and may decrypt the received data if needed. The processing device may generate an error detection code for the received data, and may determine whether a generated value is the same as the value of an error detection code included in the received data by comparison.

When the generated value is not the same as the received value, the processing device may determine that an error (e.g., a transmission error) has occurred during transmission of the data for a corresponding node or element.

When determining that the error has occurred during the transmission of the received data (e.g., the serialized data), the processing device may initialize a data value of the node where the error has occurred, rather than using the value of the node where the error has occurred before transmitting values of the received data to the remaining layers of a neural network model.

Initializing a data value for a node of a neural network model may include configuring the data value to an initial value at which the node starts learning for each layer's characteristic. For example, when a layer uses 0 to indicate a neutral state of not being trained, the data value of a node may be initialized to 0. When the neutral state is 0.5 or 1, the data value of the node may be initialized to 0.5 or 1. For example, when an eigenvector is designated, the matrix of array data may be initialized to an eigenvector.

A data value for initialization for each layer may be specified in a model graph or serialized header or determined through communication between a UE and a server.

An embodiment of the disclosure may provide a method for overcoming a transmission error through error learning.

When data of a node in which a transmission error is determined to have occurred is initialized, the possibility of the node being an outlier is eliminated, and the node operates in an initial learning state, which may be interpreted, from the perspective of learning or inference of the entire model, such that a specific node (e.g., a node with an error having occurred) among one or more nodes responding to a certain input does not respond thereto.

Reinterpreting this phenomenon, when there is a combination of a series of nodes that show a large or small response to a certain input pattern and learning of the combination is performed, if the combination of the series of nodes shows a response, even though output values of some nodes are not provided, it may be expected that output values of the nodes may be inferred.

Therefore, the method for overcoming the transmission error proposed in the disclosure may detect an error in received serialized data, may change the data in which the error is detected to an initial value, may apply output of a last layer of the split previous operation to an error learning layer, and may apply output of the error learning layer as input to a subsequent layer of a split neural network model in split processing of a neural network model network.

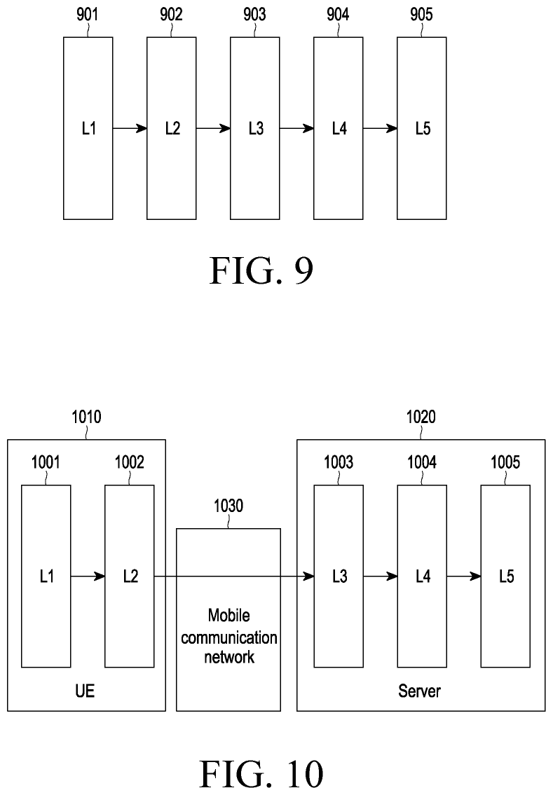

FIG. 9 illustrates a plurality of layers of a neural network model according to an embodiment of the disclosure.

Referring to FIG. 9, the neural network model may include five layers, for example, a first layer (L1) 901, a second layer (L2) 902, a third layer (L3) 903, a fourth layer (L4) 904, and a fifth layer (L5) 905.

FIG. 10 illustrates split processing in a plurality of processing devices according to an embodiment of the disclosure.

Referring to FIG. 10, among a plurality of layers, first and second layers (L1 and L2) 1001 and 1002 and third to fifth layers (L3, L4, and L5) 1003, 1004, and 1005 may be split and processed by a UE 1010 (e.g., the UE 110) and a server 1020 (e.g., the server 120). Output (e.g., intermediate data) of a last layer (e.g., second layer (L2)) of a split previous operation may be transmitted from the UE 1010 to the server 1020 via a mobile communication network 1030 (e.g., the network 100).

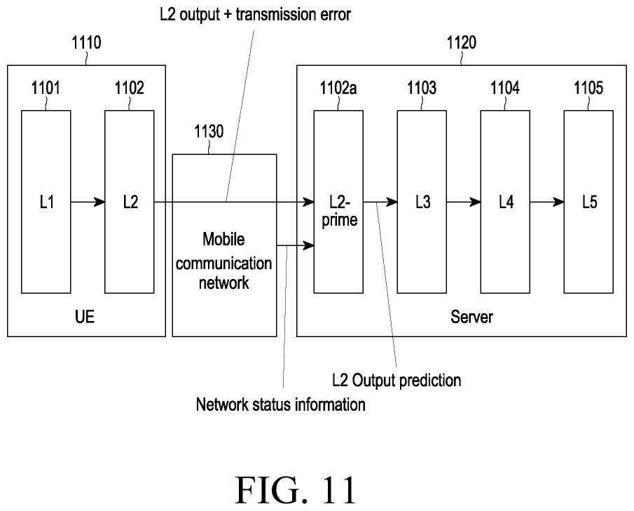

FIG. 11 is a diagram illustrating a response to a transmission error in split processing according to an embodiment of the disclosure.

Referring to FIG. 11, intermediate data (e.g., L2 output), which is output of a first layer (L1) 1110 and a second layer (L2) 1102 of a UE 1110, may include a transmission error while being transmitted via a mobile communication network 1130. The intermediate data including the transmission error may be connected to a first layer (e.g., a tpqjsWo layer (L3) 1103 of a server 1120) of a subsequent operation after passing through an error learning layer (e.g., L2-prime) 1102a of the server 1120.

L2 1102 as the last layer of the previous operation, L2-prime 1102a that has learned the output of L2, and L3 1103 that receives output of L2-prime as L2 input are illustrated. When a neural network model is split between the second layer L2 1102 and the third layer L3 1103, the output of L2 1102 may be serialized and transmitted from the UE 1110 to the server 1120. The server 1120 may receive the serialized data, may process the serialized data by L2-prime 1102a that has learned an output pattern of L2 1102 before applying the serialized data as L3 input to L3 1103, and may apply the output of L2-prime 1102a to L3 1103. The output of L3 1103 may be processed through subsequent layers (e.g., L4 1104 and L5 1105), thereby deriving final output.

The L2-prime layer 1102a may be configured to learn to generate an expected value of the L2 layer 1102 for a node identified as having an error with normal output (normal value) of L2 1102, output (error value) mixed with randomly initialized node data, and status information (e.g., a report related to a network status) of the mobile communication network 1130 as input.

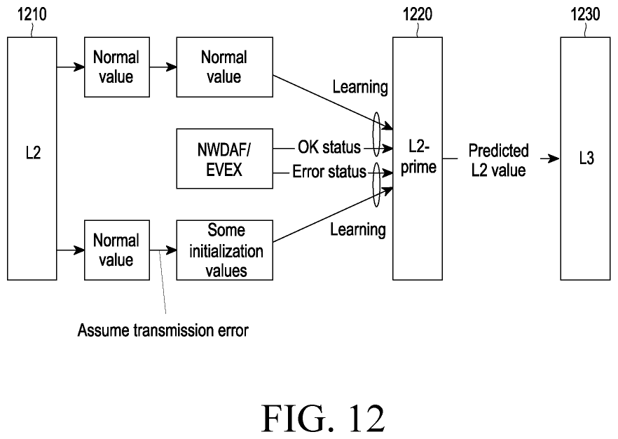

FIG. 12 is a diagram illustrating an error learning layer trained with a normal value, an error value, and a network status according to an embodiment.

Referring to FIG. 12, status information (e.g., a 3GPP NWDAF report and/or an EVEX report) indicating a network status of a mobile communication network 1130 may include at least one of the following information:
User data traffic and pattern;
Location, mobility, and usage of user device;
Network infrastructure and service statuses;
Network and service bottleneck situations;
Quality-of-service (QoS) information;
Radio access network (RAN) and core network statuses;
Real-time traffic analysis data;
Network security status;
Fault diagnosis and prevention data; and/or
Data analysis information for machine learning algorithm.

In split processing of a neural network model, at least one processing device (e.g., the server 120) may additionally include an error learning layer (e.g., L2-prime 1220) that assumes a transmission error and learns the transmission error together with a transmission status in a serialization and transmission section for intermediate data between split points considered as appropriate branching points, that is, a layer (e.g., L2 1210) and a layer (e.g., L3 1230). The error learning layer (e.g., L2-prime 1220) may be configured to learn output of a previous layer or, additionally, to learn to maintain the accuracy of an overall inference result.

When a neural network model is configured to include split processing, if a transmission error occurs in a result value received from a previous processing device (e.g., the UE 110), a subsequent processing device (e.g., the server 120) may generate a normal value using a network status as additional input through a layer (e.g., an error learning layer) that infers the normal value before occurrence of the error by a network (e.g., the network 100).

The neural network model may further include a layer (e.g., error learning layer L2-prime) trained for a special purpose (e.g., error mitigation) between intermediate layers for transfer learning. The error learning layer may be added between a layer (e.g., L2) and a layer (e.g., L3), based on a point where split processing is performed, and then connected to the layers (e.g., L2 and L3).

In an embodiment, in a neural network model that receives an image as input and provides inference, a base model may include five layers (e.g., L1, L2, L3, L4, and L5), and a split point may be determined to be between a second layer (L2) and a third layer (L3) of the base model for split processing.

Table 7 below shows an example of a code that imports trained_model.h5 as a trained model and inputs the same into a base_model variable in a neural network technology, such as Keras.

TABLE 7

from keras.models import Model
from keras.layers import Input, Dense, Dropout, LSTM
base_model = load_model(‘trained_model.h5’)

As shown in Table 8 below, the base_model variable may be stored as x1 and x2 so that some layers are processed in a first processing device.

TABLE 8

x1 = base_model.layers[:2].output
x2 = base_model.layers[2:].output

An example of a neural network model including an error learning layer for a transmission error may be configured as shown in Table 9 below. The example illustrates an error learning layer that receives a packet error rate as input and predicts a normal value through long-term and/or short-term learning. The neural network model including the error learning layer may be further advanced by learning the accuracy, complexity, and diversity of status information received from a transmission network, and may improve the accuracy of error prediction by using more and more complex parameters through learning.

TABLE 9

packetError_input = Input(shape=(1,))
y = Dense(32, activation=‘relu’)(packetError_input)
y = Dropout(0.2)(y)
y = Dense(64, activation=‘relu’)(y)
y = Dropout(0.2)(y)
y = LSTM(32)(y)
y = Dense(1, activation=‘sigmoid’)(y)

A first part of base_model of x1, an error learning model of y, and the remainder of base_model of x2 may be configured to be combined as shown in Table 10. A new integrated model of model may be generated, and a weight of the base model may be inherited and used as is.

TABLE 10

z = concatenate([x1, y, x2])
model = Model(inputs=[base_model.input, packetError_input],
outputs=z)
for i in range(0,2): # x1 weight copy
model.layers[i].set_weights(base_model.layers[i].get_weights( ))
for i in range(2,5): # x2 weight copy
j=i+len(y.layer)
model.layers[j].set_weights(base_model.layers[i].get_weights( ))

The integrated model completely configured is compiled for use, and then performs inference using an image and a network transmission status as input as shown in Table 11.

TABLE 11

```
  model.compile(loss=‘binary_crossentropy’, optimizer=‘adam’,
metrics=[‘accuracy’])
  output = model.predict([image_input, packetError_test])
```

Embodiments of the disclosure may split an already trained network using the foregoing method, receive a packet error rate that may occur during transmission as an additional factor, and continue to infer the remaining network.

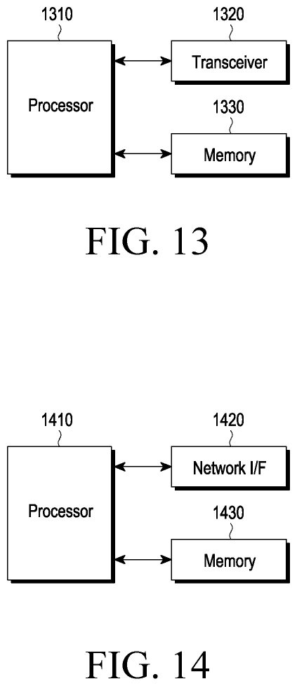

FIG. 13 is a diagram illustrating a structure of a UE in a communication system according to an embodiment of the disclosure.

Referring to FIG. 13, a UE (e.g., the UE 110) may include a processor 1310, a transceiver 1320, and memory 1330. The processor 1310, the transceiver 1320, and the memory 1330 may operate according to the above-described communication methods of the UE 110. However, components of the UE 110 are not limited to the above-described example. For example, the UE 110 may include a larger or smaller number of components than the above-described components. In addition, the processor 1310, the transceiver 1320, and the memory 1330 may be implemented in the form of a single chip. The processor 1310 may include one or more processing circuitry.

The transceiver 1320 may include reception circuitry and transmission circuitry of the UE 110, and may transmit/receive signals with other devices (e.g., base stations or servers 120). To this end, the transceiver 1320 may include a radio frequency (RF) transmitter configured to up-convert and amplify the frequency of transmitted signals, an RF receiver configured to low-noise-amplify received signals and down-convert the frequency thereof, and the like. However, this is only an embodiment of the transceiver 1320, and the components of the transceiver 1320 are not limited to the RF transmitter and the RF receiver.

In addition, the transceiver 1320 may receive signals through a radio channel, output the same to the processor 1310, and transmit signals output from the processor 1310 through the radio channel.

The memory 1330 may store programs and data necessary for the operations of the UE. In addition, the memory 1330 may store control information or data included in signals acquired by the UE 110. The memory 1330 may include a storage medium such as a read only memory (ROM), a random access memory (RAM), a hard disk, a compact disk (CD)-ROM, or a digital video disk (DVD), or a combination of storage media. The memory 1330 may be configured to be at least partially included in the processor 1310.

The processor 1310 may control a series of operations so that the UE 110 can operate according to the above-described embodiments of the disclosure. The processor 1310 may control a series of operations so that the UE 110 may operate according to the foregoing embodiments of the disclosure. In an embodiment, the processor 1310 may be configured to obtain configuration information about a transmission mode of intermediate data by split processing of a neural network, generate result values through processing of at least one first layer (e.g., L2) among a plurality of layers forming the neural network, generate the intermediate data (e.g., the serialized data 800) by attaching error detection codes for the result values to the result values, based on the configuration information, and transmit the generated intermediate data to a server 120 including at least one subsequent second layer (e.g., L3) among the plurality of layers via the transceiver 1320.

FIG. 14 is a block diagram illustrating a structure of a server in a communication system according to an embodiment of the disclosure.

Referring to FIG. 13, a server (e.g., the server 120) may include a processor 1410, a network interface (I/F) 1420, and memory 1430. The processor 1410, the network interface 1420, and the memory 1430 may operate according to the above-described communication method of the server 120. However, components of the server 120 are not limited to the above-described example. For example, the server 120 may include a larger or smaller number of components than the above-described components. In addition, at least one of the processor 1410, the network interface 1420, and the memory 1430 may be implemented in the form of a single chip. The processor 1410 may include one or more processing circuitry.

The network interface 1420 may include a receiver and a transmitter of the server 120, and may transmit/receive signals with other devices (e.g., UEs 110 or network entities).

The memory 1430 may store programs and data necessary for the operations of the server 120. In addition, the memory 1430 may store control information or data included in signals acquired by the server 120. The memory 1430 may include storage media such as a ROM, a RAM, a hard disk, a CD-ROM, and a DVD, or a combination of storage media. The memory 1430 may be configured to be at least partially included in the processor 1410.

The processor 1410 may control a series of operations so that the server 120 can operate according to the above-described embodiments of the disclosure.

The processor 1410 may control a series of operations so that the server 120 may operate according to the foregoing embodiments of the disclosure. In an embodiment, the processor 1410 may be configured to obtain configuration information about a transmission mode of intermediate data by split processing of a neural network, receive the intermediate data (e.g., the serialized data 800) including result values through processing of at least one first layer (e.g., L2) among a plurality of layers forming the neural network and error detection codes for the result values from a UE 110, identify whether there is an error in the intermediate data, based on the error detection codes, process the result values of the intermediate data by a second layer (e.g., L2-prime) trained to correspond to the first layer when the error is detected in the intermediate data, and drive a final result by processing output of the second layer by at least one third layer (e.g., L3) following the first layer among the plurality of layers.

In the disclosure as described above, elements are expressed in the singular or the plural according to presented detailed embodiments. However, the singular form or plural form is selected appropriately to the presented situation for the convenience of description, and the disclosure is not limited by elements expressed in the singular or the plural, and either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method performed by a user equipment (UE) in a communication system, the method comprising:
obtaining configuration information for a transmission mode of intermediate data by split processing of a neural network;
generating result values through processing of at least one first layer among a plurality of layers forming the neural network;
generating the intermediate data by attaching error detection codes for the result values to the result values, based on the configuration information; and
transmitting, to a server, the generated intermediate data including at least one subsequent second layer among the plurality of layers.

2. The method of claim 1, wherein the configuration information includes information indicating attributes of the intermediate data.

3. The method of claim 2, wherein the attributes include at least one of a header format, a number of data transmissions, a total data size before compression, a data compression method, a data compression range, an identifier of a layer in data, a number of nodes in data, a data array size per node, a data format per node, a storage size of a data format, an error detection method for data, a storage size of an error detection code, an order in which data and an error detection code are specified, or a node initialization value.

4. A method performed by a server in a communication system, the method comprising:
obtaining configuration information for a transmission mode of intermediate data by split processing of a neural network;
receiving, from a user equipment (UE), the intermediate data including result values through processing of at least one first layer among a plurality of layers forming the neural network and error detection codes for the result values;
identifying whether there is an error in the intermediate data, based on the error detection codes;
processing the result values of the intermediate data by a second layer trained to correspond to the at least one first layer in case that the error is detected in the intermediate data; and
deriving a final result by processing output of the second layer by at least one third layer following the at least one first layer among the plurality of layers.

5. The method of claim 4, wherein the configuration information includes information indicating attributes of the intermediate data.

6. The method of claim 5, wherein the attributes include at least one of a header format, a number of data transmissions, a total data size before compression, a data compression method, a data compression range, an identifier of a layer in data, a number of nodes in data, a data array size per node, a data format per node, a storage size of a data format, an error detection method for data, a storage size of an error detection code, an order in which data and an error detection code are specified, or a node initialization value.

7. The method of claim 4, wherein the at least one third layer is configured to predict normal values by the at least one first layer, based on the result values included in the intermediate data.

8. A user equipment (UE) in a communication system, the UE comprising:
a transceiver; and
at least one processor coupled to the transceiver, wherein the at least one processor is configured to:
obtain configuration information for a transmission mode of intermediate data by split processing of a neural network;
generate result values through processing of at least one first layer among a plurality of layers forming the neural network;
generate the intermediate data by attaching error detection codes for the result values to the result values, based on the configuration information; and
transmit, to a server, the generated intermediate data including at least one subsequent second layer among the plurality of layers.

9. The UE of claim 8, wherein the configuration information includes information indicating attributes of the intermediate data.

10. The UE of claim 9, wherein the attributes include at least one of a header format, a number of data transmissions, a total data size before compression, a data compression method, a data compression range, an identifier of a layer in data, a number of nodes in data, a data array size per node, a data format per node, a storage size of a data format, an error detection method for data, a storage size of an error detection code, an order in which data and an error detection code are specified, or a node initialization value.

11. A server in a communication system, the server comprising:
a network interface; and
at least one processor coupled to the network interface, wherein the at least one processor is configured to:
obtain configuration information for a transmission mode of intermediate data by split processing of a neural network;
receive, from a user equipment (UE), the intermediate data including result values through processing of at least one first layer among a plurality of layers forming the neural network and error detection codes for the result values;
identify whether there is an error in the intermediate data, based on the error detection codes;
process the result values of the intermediate data by a second layer trained to correspond to the at least one first layer when the error is detected in the intermediate data; and
derive a final result by processing output of the second layer by at least one third layer following the at least one first layer among the plurality of layers.

12. The server of claim 11, wherein the configuration information includes information indicating attributes of the intermediate data.

13. The server of claim 12, wherein the attributes include at least one of a header format, a number of data transmissions, a total data size before compression, a data compression method, a data compression range, an identifier of a layer in data, a number of nodes in data, a data array size per node, a data format per node, a storage size of a data format, an error detection method for data, a storage size of an error detection code, an order in which data and an error detection code are specified, or a node initialization value.

14. The server of claim 11, wherein the at least one third layer is configured to predict normal values by the at least one first layer, based on the result values included in the intermediate data.
